(19) United States
(12) Patent Application Publication
(10) Pub. No.: US 2010/0115254 A1
(43) Pub. Date: May 6, 2010

(54) Synchronization in Multiple Environments

(76) Inventors: Thomas Deng, Redwood City, CA (US); Mark M. Lee, Saratoga, CA (US); Victor E. Chin, San Jose, CA (US); Robert Ha, Saratoga, CA (US); Sergel Krupenin, Redwood City, CA (US); Chun-Ming Tsao, Taipei (TW); Jian-Jung Shiu, Taipei (TW)

Correspondence Address: GLENN PATENT GROUP, 3475 EDISON WAY, SUITE L, MENLO PARK, CA, 94025, US

(21) Appl. No.: 12/610,170

(22) Filed: Oct. 30, 2009

Related U.S. Application Data
(60) Provisional application No. 61/109,609, filed on Oct. 30, 2008.
(60) Provisional application No. 61/239,383, filed on Sep. 2, 2009.

(51) Int. Cl. G06F 9/00; G06F 17/30

(52) U.S. Cl. 713/1; 707/620; 707/E17.005

(57) ABSTRACT

A method and apparatus for synchronizing different environments in response to a change in one of the environments. The term environment encompasses operating systems, virtual machines, and states. The synchronization functions when one environment controls a master file or the environments access a shared folder. The synchronization is one-way or two-ways. The synchronization applies to digital photos, personal information management data, shared maps and directions, documents, configuration data, network settings, browser data sync, account information for accessing the client, and local and web applications.

### CROSS REFERENCE TO RELATED APPLICATIONS

This patent application claims priority to U.S. provisional patent application Ser. No. 61/109,609, Multiple Operating System Environment, filed Oct. 30, 2008 and U.S. provisional patent application Ser. No. 61/239,383, Using a Software Configuration Tool to Customize a Computer's Power-On Methods, filed Sep. 2, 2009.

### BACKGROUND OF THE INVENTION

1. Technical Field

This invention relates generally to the field of virtualization. More specifically, this invention relates to reducing the time required to load virtual applications.

2. Description of the Related Art

An operating system (OS) in a computer serves as an intermediate between the computer hardware and software applications. Computers can run multiple operating systems for different reasons. For example, some software only runs on an OS that a user does not want as a default OS. Specifically, many people want the default OS to be Linux, but they need to use Microsoft® Word for word processing tasks. In this case, many companies offer a virtual machine (VM) to handle requests between the different operating systems.

Alternatively, a computer can run a default OS and a second, lighter OS that performs certain tasks more quickly. DeviceVM® provides Splashtop® software that suspends the default OS and launches the second OS in about three seconds.

Users want consistency, especially when they are using the same computer, even if they are using different operating systems on the same computer. Thus, a problem arises when the user makes a change in one OS that is not reflected in the second OS. For example, if a user alters a user preference in the second OS, the user preference should be modified in the default OS as well.

In addition to user preferences, a user is more likely to accept a second OS or VM if it has a similar look and feel to the default OS. For example, if the icon for a music program looks different depending upon the OS or VM, the user may find the effect too jarring.

When the default OS is suspended and the computer switches to using the second OS, the state information for the default OS is recorded. If changes are made in the default OS, the changes cannot simply be added directly to the user preferences section of the default OS because it could interfere with the default OS transitioning back to an active state.

What is needed is a system and method for achieving a consistency between different environments.

### SUMMARY OF THE INVENTION

The present invention overcomes the deficiencies and limitations of the prior art by providing a system and method for synchronizing different environments when a change is made to only one of the environments. The term environment applies to different operating systems (OS), virtual machines, and states. For example, the client runs a default OS, and a light OS. Alternatively, the client runs two full operating systems that are managed as virtual machines.

In one embodiment, the system generates a user interface (UI) that is displayed in any environment, including different states, to provide the user with a consistent UI. The UI is generated in response to selection of a home key, such as a power key on a personal computer, a home key on a mobile phone, a mouse, Bluetooth, peripherals, an icon on the display, etc. In one embodiment, the home key is reassigned from its original function to being associated with displaying the UI.

The synchronization applies to digital photos, personal information management (PIM) data, shared maps and directions, documents, configuration data, network settings, browser data sync, account information for accessing the client, and local and web applications.

The synchronization system is incorporated into the hardware and sold with the client or the synchronization system is sold separately as software.

### BRIEF DESCRIPTION OF THE DRAWINGS

FIG. 1 illustrates a block diagram of a synchronization system;

FIG. 2 illustrates a block diagram of synchronization between different environments;

FIG. 3 illustrates a flow diagram for synchronizing between different environments;

FIG. 4A is a flow diagram for synchronizing photos from a digital camera wherein the second OS controls the master folder;

FIG. 4B a flow diagram for synchronizing photos from a digital camera wherein the default OS and the second OS access a shared folder;

FIG. 4C is a flow diagram for synchronizing photos from a digital camera wherein the photos are stored on a web server;

FIG. 5A is a flow diagram for synchronizing PIM data where the default OS controls the master data;

FIG. 5B is a flow diagram for synchronizing PIM data where the default OS and the second OS access the same PIM data source;

FIG. 6A is a flow diagram for synchronizing maps and driving directions where the default OS and the second OS access the same folder;

FIG. 6B is a flow diagram for synchronizing maps and driving directions where the second OS controls the master data;

FIG. 7A is a flow diagram for synchronizing configuration data where the default OS contains the directly readable master data;

FIG. 7B is a flow diagram for synchronizing configuration data where the default OS is the master and the configuration settings are not directly readable outside the OS;

FIG. 7C a flow diagram that illustrates the steps for synchronizing configuration data for a two-way sync;

FIG. 8A is a flow diagram for synchronizing network data wherein the default OS contains the directly readable master data;

FIG. 8B is a flow diagram for synchronizing network data wherein the default OS is the master and the configuration settings are not directly readable outside the OS;

FIG. 8C a flow diagram that illustrates the steps for synchronizing network data for a two-way sync;

FIG. 9A is a flow diagram that illustrates the steps for synchronizing account data wherein the default OS controls a directly readable master file;

FIG. 9B is a flow diagram that illustrates the steps for synchronizing account data wherein the default OS controls the master file; and

FIG. 10 is a flow diagram that illustrates the steps for synchronizing local and web applications from a second OS to a default OS.

### DETAILED DESCRIPTION OF THE INVENTION

A method and apparatus for synchronizing between different environments.

### System Architecture

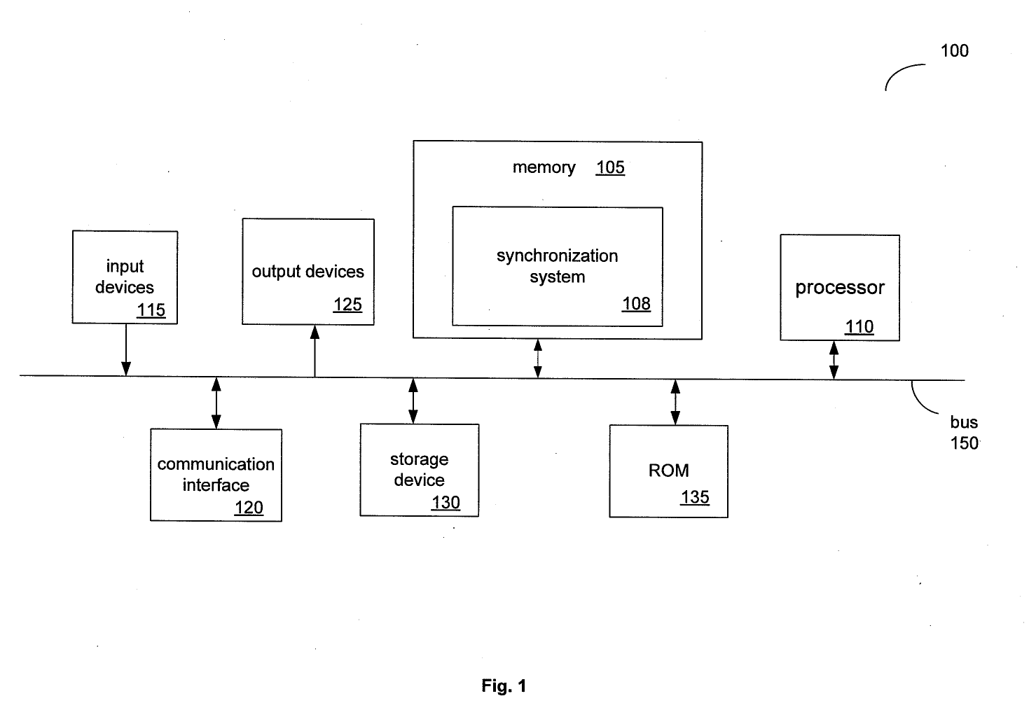

In one embodiment, the client 100 comprises a computing platform configured to act as a client device, e.g. a personal computer, a netbook, a notebook, a smart phone, a digital media player, a personal digital assistant, etc. FIG. 1 is a block diagram of a client 100 according to one embodiment of the invention. The client 100 includes a bus 150, a processor 110, a main memory 105, a read only memory (ROM) 135, a storage device 130, one or more input devices 115, one or more output devices 125, and a communication interface 120. The bus 150 includes one or more conductors that permit communication among the components of the client 100.

The processor 110 includes one or more types of conventional processors or microprocessors that interpret and execute instructions. Main memory 105 includes a static random access memory (SRAM) device, a dynamic random access memory (DRAM) device, or another type of storage device that stores information and instructions for execution by the processor 205. ROM 135 includes a conventional ROM device or another type of static storage device that stores static information and instructions for use by the processor 110. The storage device 130 includes a magnetic and/or optical recording medium and its corresponding drive.

Input devices 115 include one or more conventional mechanisms that permit a user to input information to a client 100, such as a keyboard, a mouse, etc. Output devices 125 include one or more conventional mechanisms that output information to a user, such as a display, a printer, a speaker, etc. The communication interface 120 includes any transceiver-like mechanism that enables the client 100 to communicate with other devices and/or systems. For example, the communication interface 120 includes mechanisms for communicating with another device or system via a network.

The software instructions that define the synchronization system 108 are to be read into memory 105 from another computer readable medium, such as a data storage device 130, or from another device via the communication interface 120. The processor 110 executes computer-executable instructions stored in the memory 105. The instructions comprise object code generated from any compiled computer-programming language, including, for example, C, C++, C# or Visual Basic, or source code in any interpreted language such as Java or JavaScript.

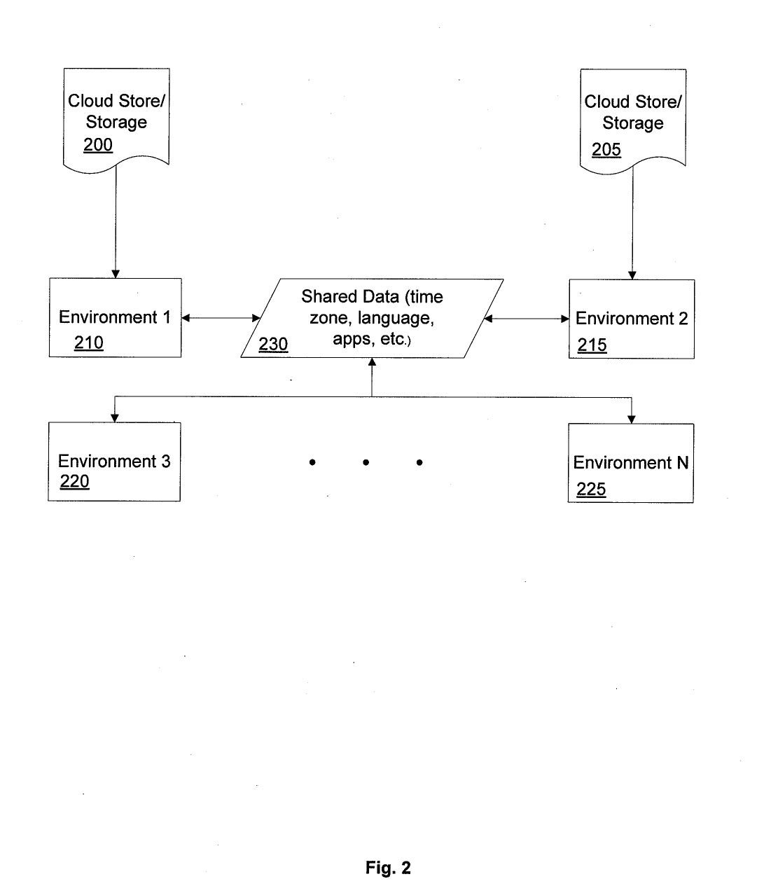

FIG. 2 is a block diagram of the different environments. The environments receive their data from local or remote storage (cloud store/storage 200 205). A cloud store stores data remotely and is accessed over the Internet. Storage refers to the memory 105 that is part of the client 100. The environments (Environment 1 210, Environment 2 215, Environment 3 220, and Environment N 225) include operating systems, different states for the same OS, and virtual machines. All environments access the same shared data 230. In one embodiment, the shared data 230 is a single file. In another embodiment, the shared data 230 takes the form of multiple files. The shared data 230 is stored at any location including the hard drive, onboard flash, external flash, RAM, and remotely in the cloud store. When changes are made in one environment, a synchronization agent changes the shared data 230.

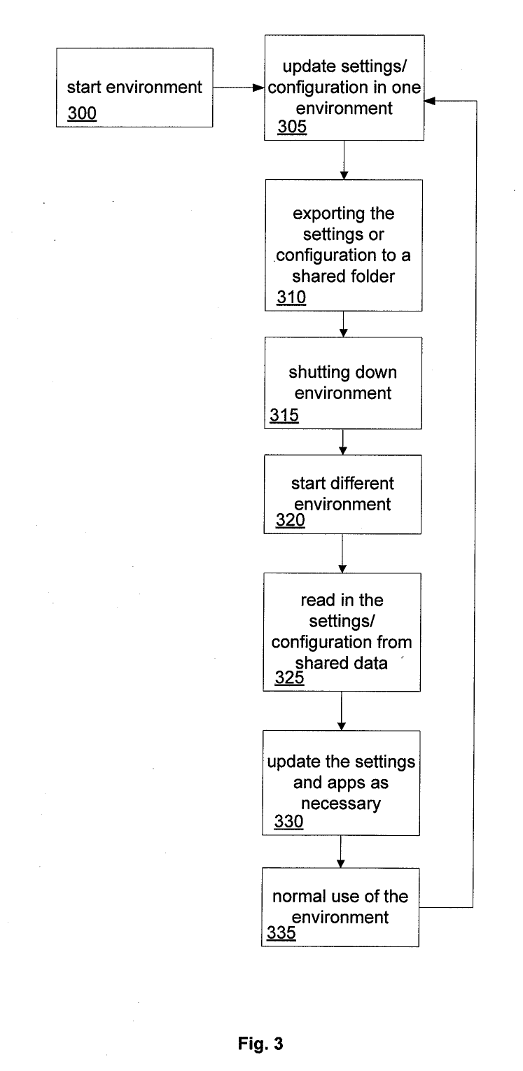

FIG. 3 is a flow diagram that illustrates the steps for synchronizing between different environments. The client 100 starts 300 an environment, such as Environment 1 210. The client 100 receives 305 an update of the settings or configurations in one of the environments. The settings and configurations are changed by a user or by the client during an automatic process. For example, operating systems use the Greenwich Mean Time (GMT) clock as a reference for the internal clock and add/subtract from the reference to establish the user's time zone. When the user first sets the time or alters the time zone setting, a synchronization agent changes the shared data 230 to reflect the new time zone.

Other setting and configuration data include adding a bookmark to the favorites, inputting login information such as a username and password, adding a new contact to an address book, personal information manager (PIM) data, network settings, browser data, map snapshots etc. The user can also configure the appearance of the background, individual icons in a docking bar, etc. The client 100 can also synchronize media between different environments. Media includes digital photographs, documents, and local and web applications. Specific examples of the type of data being synchronized are described in greater detail below.

A synchronization agent exports 310 the settings or configuration data to a shared folder 230. For example, the synchronization agent exports a data folder and an index file to c:\temp\tmpdvmexp. where “c:” is a Windows® system drive. The synchronization agent takes the form of any executable format for the OS, such as a plug-in dynamic-link library for Microsoft® Office Outlook®, an external dynamic-link library loaded by an export service, etc. The export flow runs as follows: first, search index files in the C drive under c:\temp\tmpdvmexp. Copy the export data files to c:\dvmexp. Then create c:\dvmexp.idx with file path/checksum information. People of ordinary skill in the art will understand that this is merely one example of how to export data and that other implementations are possible.

The client 100 shuts down 315 the environment. This includes, for example, closing the environment by exiting out or turning off the client or merely suspending the environment.

The client 100 starts 320 a different environment, such as Environment 2 210, which reads in 325 the settings or configuration data from the shared data 230. This ensures that the data is synchronized between environments because they read from the same source. The second environment updates 330 settings and applications as necessary. A normal use 335 of the environment continues. If the user modifies any settings or configurations, the process begins again from step 305.

### EXAMPLE 1

In one embodiment, Environment 1 210 is a default OS, such as Windows® and Environment 2 215 is a second OS, such as the virtual application environment (VAE) described in U.S. Ser. No. 11/727,700, which is herein incorporated by reference. The VAE comprises a second OS that is lightweight and optimized. In one embodiment, the second OS is embedded OS that is included in the system boot ROM of a client. In another embodiment, the second OS is part of some other storage media, such as a flash drive.

The VAE is used in a pre-boot environment to suspend the default OS and to load virtual applications. The VAE loads an electronic programming guide (EPG) from boot read-only memory (ROM) or other storage media, such as a USB flash drive. The EPG is similar to the programs provided with a set-top-box in that it is easy and intuitive to use. The EPG includes a UI that is displayed with different applications for the user to select. In one embodiment, the EPG UI also includes a search bar that automatically uses a search engine to return results in response to user input.

### EXAMPLE 2

In another embodiment, the synchronization system 108 synchronizes in a dual-boot environment where Environment 1 210 is a default OS, such as Windows® and Environment 2 215 is a second full OS, such as Linux®.

### EXAMPLE 3

In yet another embodiment, the synchronization system 108 synchronizes between a default OS that experiences different system states and a second OS. For example, a default OS has the following states: SO (system on), S1-3 (sleep/standby), S4 (hibernated), and S5 (system off). Regardless of the state of the default OS, the second OS generates a UI that displays applications, provides for searching functionality, etc. The second OS UI functions as a home for the user.

In one embodiment, the second OS UI is tied to a client's power button, hotkey, or a home key. Alternatively, the synchronization system 108 reassigns the home key to any key on the client or on peripherals (keyboard, mouse, Bluetooth peripheral, etc.).

### Digital Camera Photo Sync

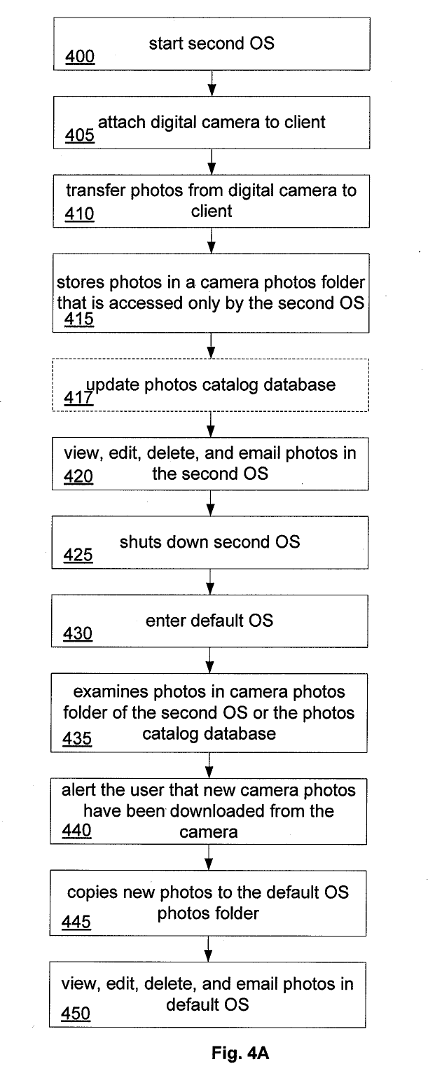

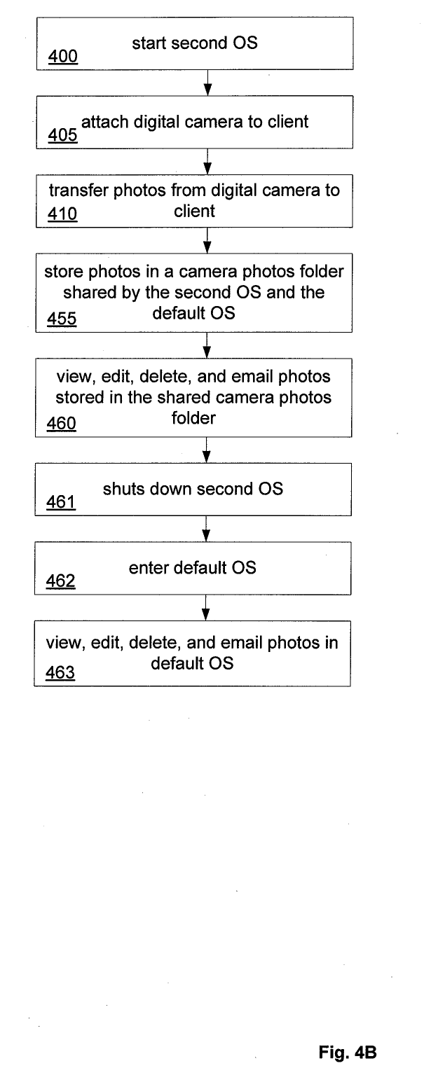

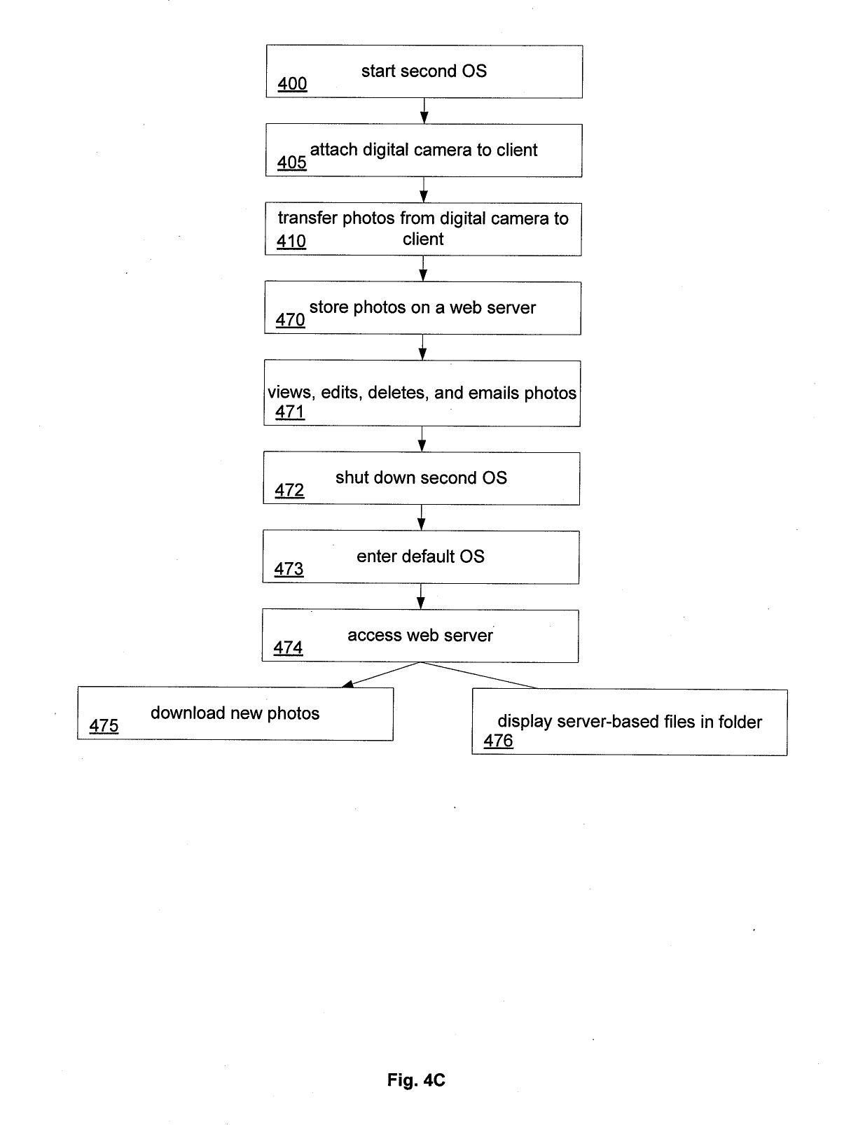

FIG. 4A is a flow diagram of steps for synchronizing photos from a digital camera on a client 100 with a default OS and a second OS that comprises a master folder. The second OS is either a lightweight OS as described in Example 1 or a second full OS as described in Example 2. The advantage of this application is that the user uploads photos from a camera to the client without waiting for the default OS to boot. This way, the user clears space on the camera's storage medium, i.e. memory card. Furthermore, the same photos are accessible when either the default OS or the second OS is active.

A user starts 400 the second OS. This can be achieved by, for example, pressing a power button to start the client 100. The user attaches 405 a digital camera to the client 100, for example, by using a universal serial bus (USB) cable. The second OS comprises a photo-sync application that transfers 410 the photos from the digital camera to the client 100.

The photo-sync application in the second OS stores 415 photos in a camera photo folder that is accessed only by the second OS. In one embodiment, the photo-sync application updates 417 a photo catalog database. The user can view 420, edit, delete, and email the photos that are stored in the camera photo folder. At some point, the user shuts down 425 the second OS, for example, by turning off the client 100 or switching to the default OS.

Once the user enters 430 the default OS, the photo sync-application in the default OS examines 435 the photos in the camera photo folder of the second OS or the photo catalog database, depending upon whether the photo catalog database embodiment is implemented.

In one embodiment, the default OS photo-sync application alerts 440 the user that new camera photos have been downloaded from the camera. The default OS photo-sync application copies 445 new photos to the default OS photo folder and updates the photo catalog database in the OS. In one embodiment, the default OS photo-sync application only performs step 445 in response to user confirmation. Once the photos are copied, the user views 450, edits, deletes, and emails the photos in the default OS.

FIG. 4B is a flow diagram of steps for synchronizing photos from a digital camera on a client 100 wherein the default OS and the second OS access a shared folder. A user starts 400 the second OS. This can be achieved by, for example, pressing a power button to start the client 100. The user attaches 405 a digital camera to the client 100, for example, by using a universal serial bus (USB) cable. The second OS comprises a second OS photo sync application that transfers 410 the photos from the digital camera to the client 100.

The second OS photo-sync application stores 455 photos in a camera photo folder that is shared by both the second OS and the default OS. The user views 460, edits, deletes, and emails photos stored in the shared camera photo folder. When the user shuts down 461 the second OS and enters the default OS, the user views 463, edits, deletes, and emails photos in the default OS.

FIG. 4C is a flow diagram of steps for synchronizing photos from a digital camera on a client 100 wherein the default OS and the second OS store the photos on a web server, i.e. the cloud store 205 that is described and associated with FIG. 2. A user starts 400 the second OS. This can be achieved by, for example, pressing a power button to start the client 100. The user attaches 405 a digital camera to the client 100, for example, by using a universal serial bus (USB) cable. The second OS comprises a photo sync application that transfers 410 the photos from the digital camera to the client 100.

The second OS photo-sync application stores 470 photos on a web server. The user views 471, edits, deletes, and emails photos. Any changes made to the photos are saved on the server. Once the user shuts down 472 the second OS and enters 473 the default OS, the photo-sync agent in the default OS accesses 474 the web server and either downloads 475 the new photos or the web server displays 476 the server-based files in a folder as if it were a local folder.

### Personal Information Management (PIM) Data Sync

The PIM data includes contacts and calendar information. By using the synchronization system 108 in combination with multiple environments, the user accesses or modifies the PIM data from any environment without worrying about where the data actually resides.

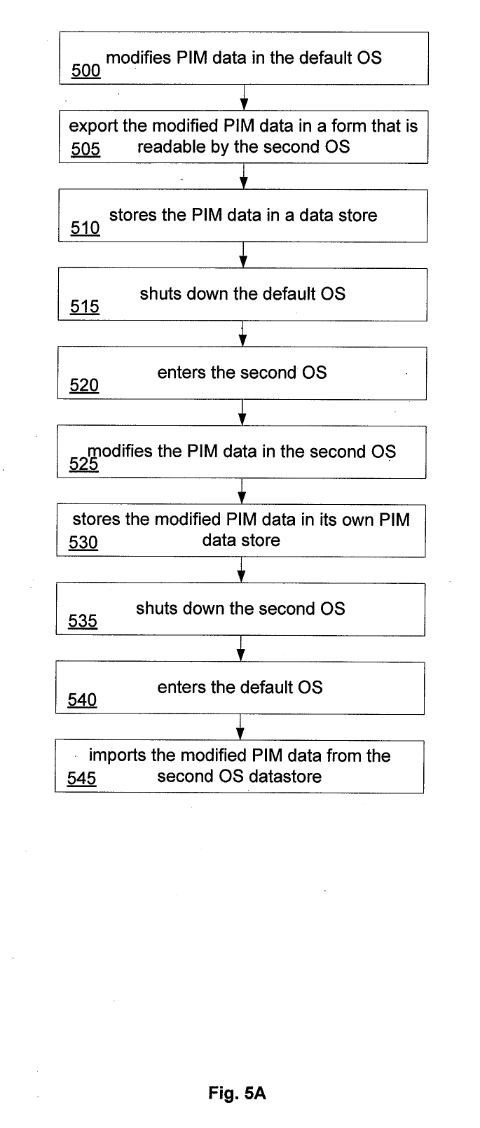

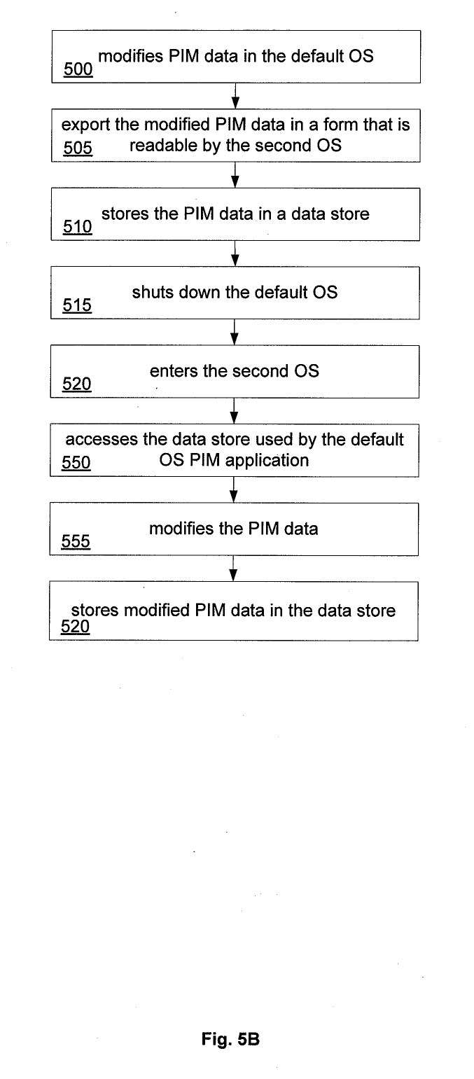

FIG. 5A is a flow diagram that illustrates the steps for synchronizing PIM data between multiple operating systems wherein the default OS is the master. The user modifies 500 PIM data in the default OS, for example, by adding or editing a contact in Microsoft® Office Outlook®. The default OS sync application exports 505 the modified PIM data in a format that is readable in the second OS. The default OS sync application stores 510 the modified PIM data in a data store, such as the hard disk drive or a web server.

When the user shuts down 515 the default OS and enters 520 the second OS, a second OS sync application provides 525 the user with the exported PIM data. The user modifies 530 the PIM data in the second OS. The second OS PIM application stores 535 the modified PIM data in its own data store, such as a local file, local database, or a web server.

The user shuts down 540 the second OS. When the user enters 545 the default OS, the PIM synch application in the default OS imports 550 the modified PIM data from the second OS data store. The modified PIM data is accessible from the default OS.

FIG. 5B is a flow diagram that illustrates the steps for synchronizing PIM data between multiple operating systems where the PIM data is stored in a shared data store. The user modifies 500 PIM data in the default OS, for example, by adding or editing a contact in Microsoft® Office Outlook®. The default OS sync application exports 505 the modified PIM data in a format that is readable in the second OS. The PIM sync application stores 510 the modified PIM data in a data store, the data store including the hard disk drive and a web server.

When the user shuts down 515 the default OS and enters 520 the second OS, the second OS PIM application accesses 550 the PIM data as stored in the data store that was used by the default OS PIM application. The user modifies 555 the PIM data. The PIM application stores 560 the modified PIM data in the same PIM data store that was used by the default OS PIM application.

### Shared Maps and Directions

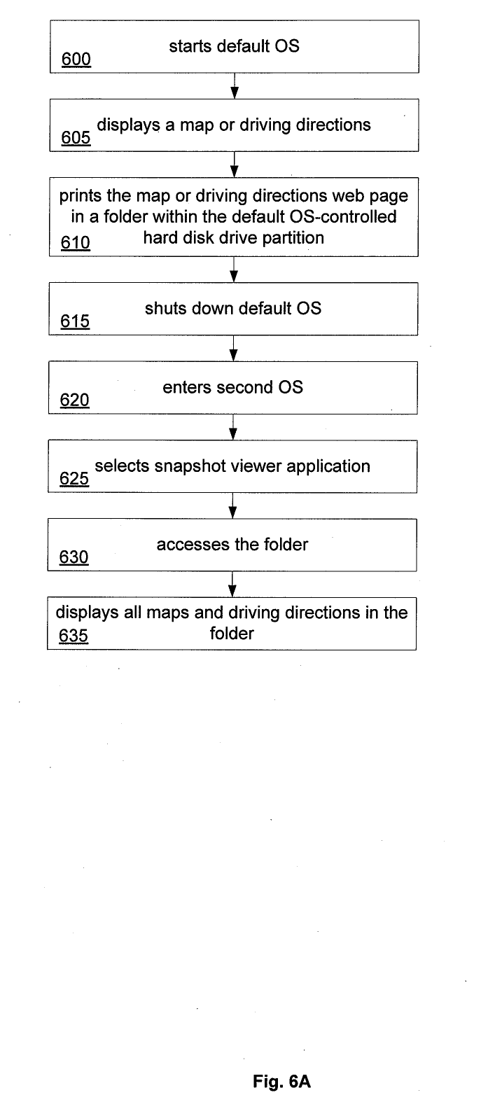

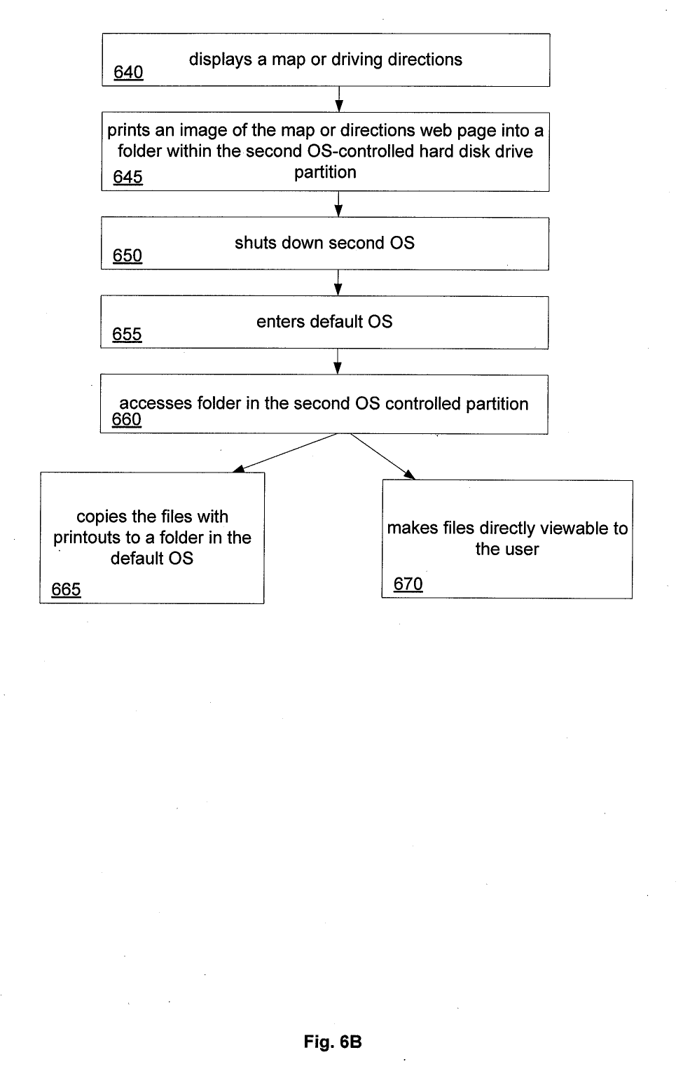

By using the synchronization system 108 in combination with multiple environments, maps and directions are accessible from any environment. FIG. 6A is a flow diagram that illustrates the steps for sharing maps and directions wherein the operating systems access the same shared folder.

The user starts 600 the default OS. The browser displays 605 a map or directions that may be saved for future use. A snapshot application prints 610 the image of the map or directions in a folder within the default OS-controlled hard disk drive partition.

The user shuts down 615 the default OS. At some point, the user enters 620 the second OS and selects 625 the snapshot viewer application. A second OS snapshot application accesses 630 the folder and displays 635 all available maps and directions in the folder, regardless of whether the snapshots were generated in the default OS or the second OS.

FIG. 6B is a flow diagram that illustrates the steps for sharing maps and directions wherein the second OS controls the master folder. The second OS browser displays 640 a map or driving directions. The second OS snapshot application prints 645 the image of the maps or directions web page into a folder within the second OS-controlled hard disk drive partition.

The user shuts down 650 the second OS. When the user enters 655 the default OS, a default OS snapshot application accesses 660 the folder in the second OS controlled partition. The default OS snapshot application copies 665 the files with printouts to a folder in the default OS or makes 670 the files directly viewable to the user.

### Documents

In one embodiment, the synchronization system 108 includes synchronization of documents. Documents include office program files, such as Word, PowerPoint, and Excel files; media files, such as music, video, and photos; and metadata, such as playlists. The synchronization process is the same as the one described for the maps and directions as described in FIGS. 6A and 6B.

### Configuration Data Sync

By using the synchronization system 108 in combination with multiple environments, the user only needs to configure the environment settings once and the settings are applied across all environments. The synchronization system 108 synchronizes the configuration settings regardless of whether the OS settings are readable when the OS is not running.

The environment data includes language, keyboard, font size, date, time, time zone, location, screen resolution, screen brightness, power options, performance options, mouse sensitivity, track pad sensitivity, idle screen saver timers, background themes, i.e. skins, icons, etc. For example, if the user customizes icons in the second OS, the synchronization system 108 changes the icons in the default OS.

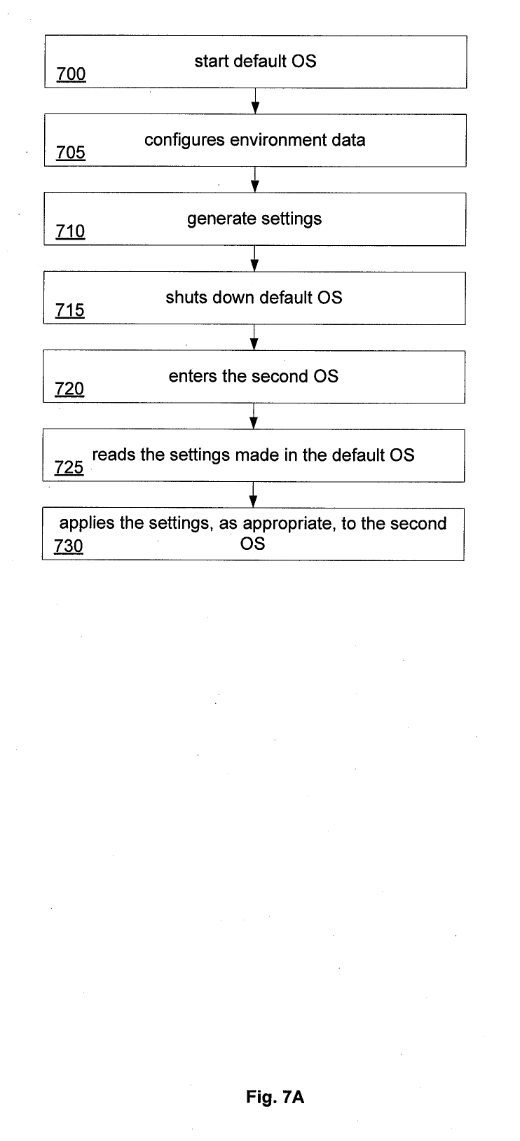

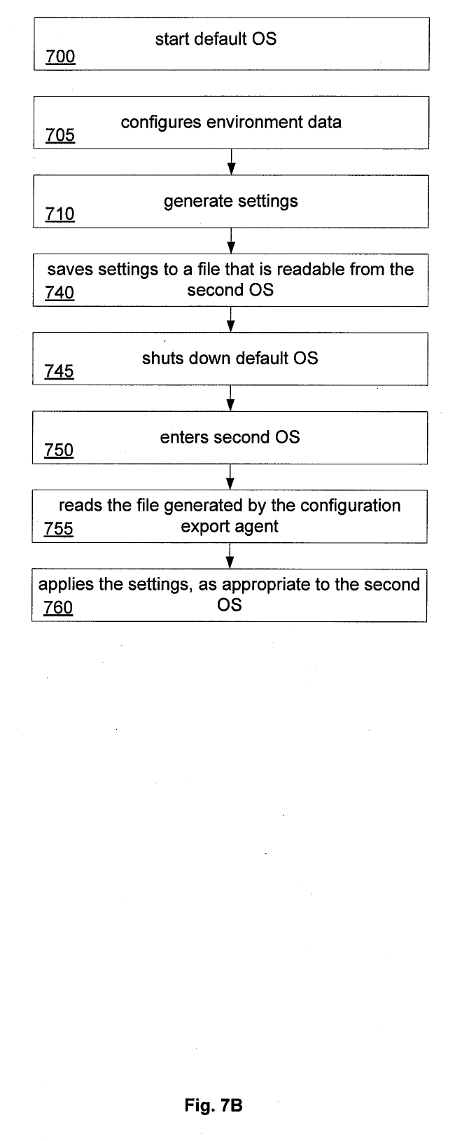

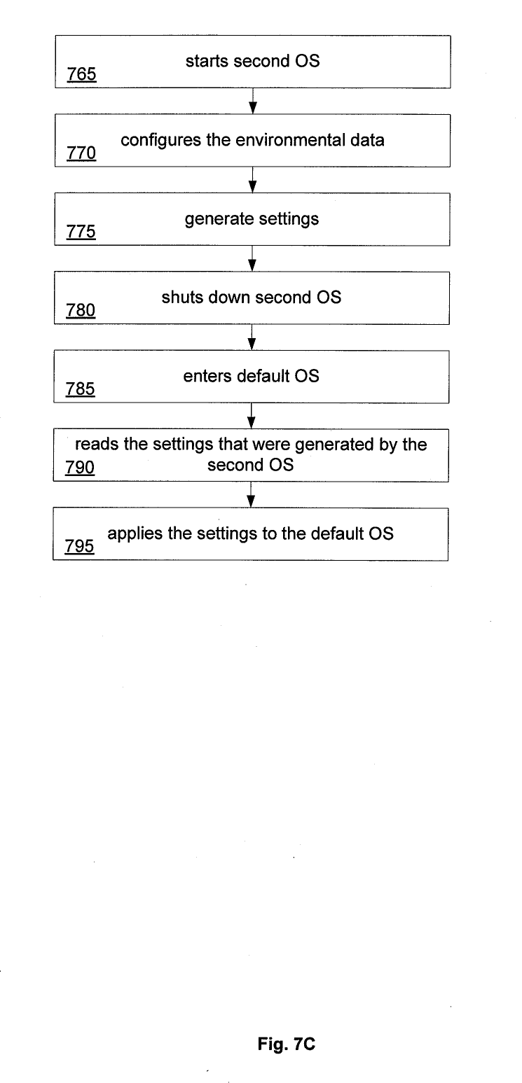

FIG. 7A is a flow diagram that illustrates the steps for synchronizing configuration data where the default OS has a directly readable master. The user starts 700 the default OS and configures 705 environment data to generate 710 settings. The user shuts down 715 the default OS. When the user enters 720 the second OS, the second OS configuration application reads 725 the settings made in the default OS and applies 730 the settings, as appropriate, to the second OS. The second OS configuration application does not apply to all settings because, for example, environmental data made to Microsoft® Word would not apply to the second OS if the second OS cannot run that program.

FIG. 7B is a flow diagram that illustrates the steps for synchronizing configuration data wherein the default OS controls the master file. The user starts 700 the default OS and configures 705 environment data to generate 710 settings. A default OS configuration export agent saves 740 the settings to a file that is readable from the second OS.

The user shuts down 745 the default OS. When the user enters 750 the second OS, a second OS configuration application reads 755 the file generated by the configuration export agent and applies 760 the settings, as appropriate, to the second OS.

FIG. 7C is a flow diagram that illustrates the steps for synchronizing configuration data for a two-way sync. The user starts 765 the second OS and configures 770 the environment data to generate 775 settings. The user shuts down 780 the second OS. When the user enters 785 the default OS, the configuration application in the default OS reads 790 the settings that were generated by the second OS and applies 795 the settings, as appropriate, to the default OS.

### Network Settings Sync

Network settings include wireless fidelity (WiFi) network names, passwords, keys, and connection priorities; whether or not the client should join open networks; 3G/wireless wide area network (WWAN) network choice, personal identification number (PIN) or password, auto-connect on/off setting, roaming on/off setting; digital subscriber line (DSL) user name and password; and internet protocol (IP) and DNS address settings. These settings change regularly and, as a result, should be synchronized between environments.

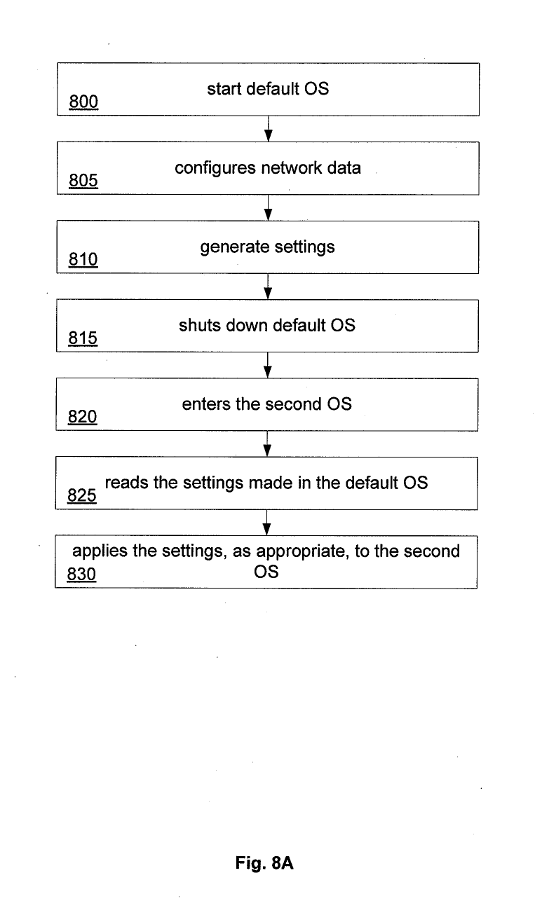

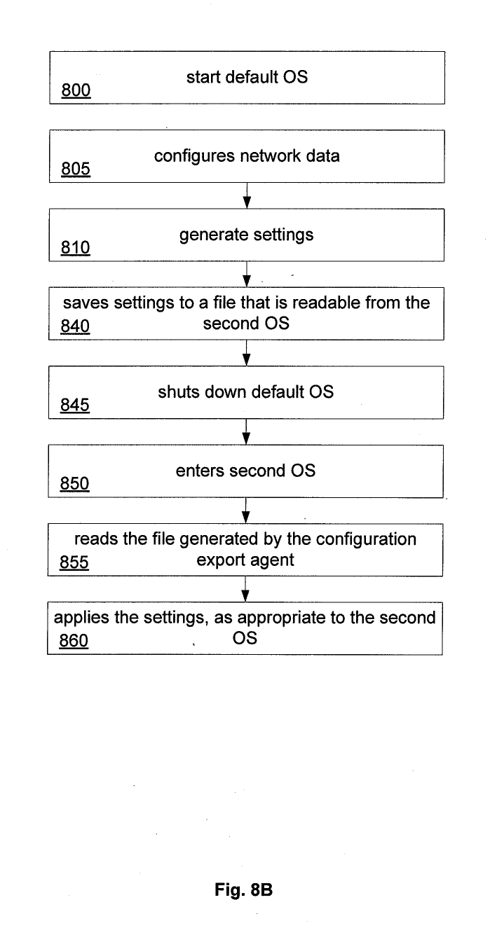

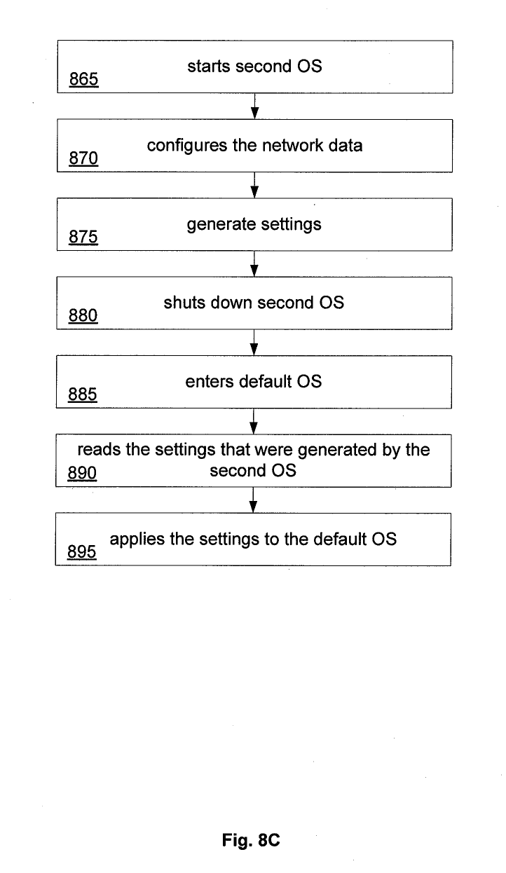

FIG. 8A is a flow diagram that illustrates the steps for synchronizing network data wherein the default OS has a directly readable master. The user starts 800 the default OS and configures 805 network data to generate 810 settings. The user shuts down 815 the default OS. When the user enters 820 the second OS, a second OS configuration application reads 825 the settings made in the default OS and applies 830 the settings, as appropriate, to the second OS.

FIG. 8B is a flow diagram that illustrates the steps for synchronizing network data wherein the default OS controls the master file. The user starts 800 the default OS and configures 805 network data to generate 810 settings. A default OS configuration export agent saves 840 the settings to a file that is readable from the second OS.

The user shuts down 845 the default OS. When the user enters 850 the second OS, a second OS configuration application reads 855 the file and applies 860 the settings, as appropriate, to the second OS.

FIG. 8C is a flow diagram that illustrates the steps for synchronizing network data for a two-way sync. The user starts 865 the second OS and configures 870 the network data to generate 875 settings. The user shuts down 880 the second OS. When the user enters 885 the default OS, a default OS configuration application reads 890 the settings and applies 895 the settings, as appropriate, to the default OS.

### Browser Data Sync

In one embodiment, the synchronization system 108 includes one-way and two-way synchronization of browser data. Browser data includes bookmarks; favorites; history; cookies; home page address; stored form data; stored username and password data for web sites; tags; folders; information used to classify bookmarks; favorites, or other websites; certificates; skins and browser customizations; add-ons; extensions; plug-ins; trusted site security lists; blocked site lists; virus patterns; default browser, last setting, etc.

When a user conducts a search using a search engine in one environment, the search history is accessible in the different environment. This way the user does not have to keep track of the environment used to perform the search. Furthermore, the user can customize the browser by, for example, configuring a search bar in one environment to use a particular search engine. The synchronization system 108 will add the search bar with the same search engine to another environment. In addition, the synchronization system 108 synchronizes default browser settings, such as from Internet Explorer to Mozilla.

The last setting refers to the last browser settings that were being used before the browser was closed. For example, the last setting includes the tabs and websites that were last open. Thus, when a user closes a browser in one environment and opens the browser in a second environment, the last settings will be displayed for the browser in the second environment.

The process for synchronizing browser is the same as for the environment and configuration data syncs described in connection with FIGS. 7A-C and 8A-C.

In one embodiment, there is also synchronization between the configuration data and the browser settings. For example, if a user modifies the configuration data so that English is the selected language, the browser settings automatically set the default search engine to Yahoo!®. If a user modifies the configuration data so that Chinese is the selected language, the browser settings set the default search engine to Baidu. The synchronization system 108 synchronizes the other environments to contain the same modifications.

### Username and Password Sync for Accessing the Client

In one embodiment, the synchronization system 108 synchronizes account settings for accessing the different environments. The account settings include usernames, passwords, biometric data, etc. The synchronization system 108 works regardless of whether OS account settings are readable when an OS is not running.

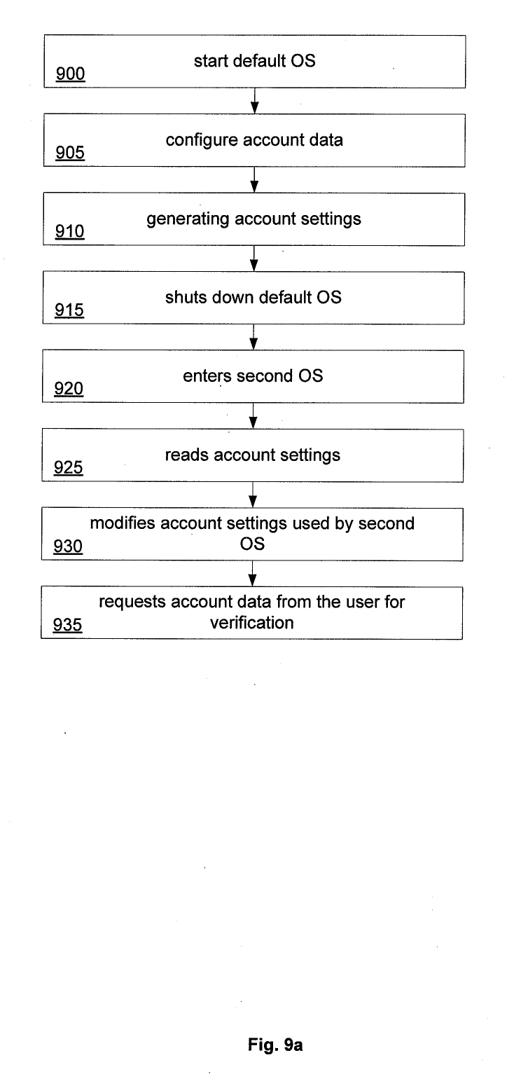

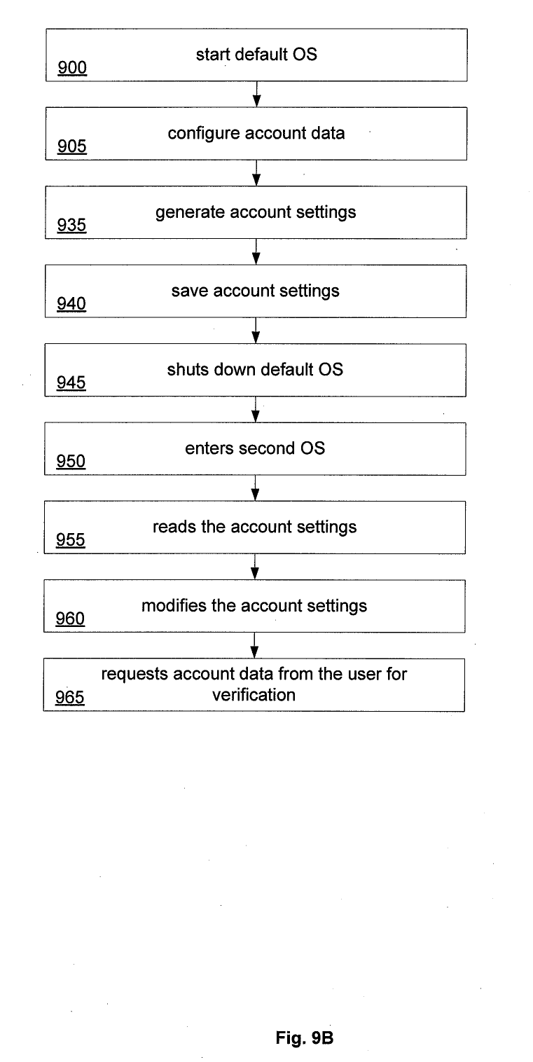

FIG. 9A is a flow diagram that illustrates the steps for synchronizing account data wherein the default OS controls a directly readable master file. The client starts 900 the default OS and configures 905 the account data for a user. In this case, the user includes administrators. The default OS generates account settings.

The user shuts down 915 the default OS. When the user enters 920 the default OS, a default OS configuration application reads 920 the account settings, modifies 925 the account settings used by the second OS, and requests 930 account data from the user for verification.

FIG. 9B is a flow diagram that illustrates the steps for synchronizing account data wherein the default OS controls the master file, which is not readable outside the default OS. The user starts 900 the default OS and configures 905 the account data. A default OS configuration export agent generates 935 account settings and saves 940 the account settings to a file that is readable from the second OS.

The user shuts down 945 the default OS. When the user enters 950 the second OS, a second OS configuration application reads 955 the account settings, modifies 960 the account settings used by the second OS, and requests 965 account data from the user for verification.

### Local and Web Application Sync

In one embodiment, the synchronization system 108 synchronizes applications and web shortcuts for the different environments. This provides the user with consistent application selections in both environments.

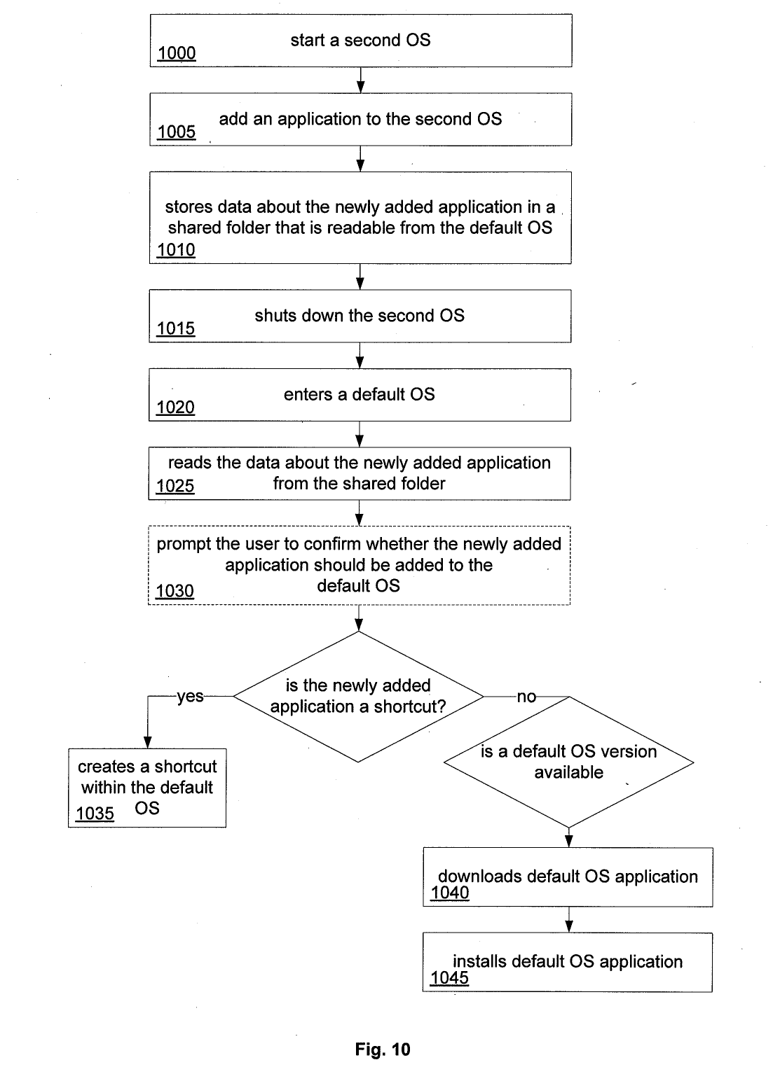

FIG. 10 is a flow diagram that illustrates the steps for synchronizing local and web applications from a second OS to a default OS. Persons of ordinary skill in the art will recognize that this process can easily be reversed to sync from the default OS to the second OS.

The client starts 1000 a second OS. The user adds 1005 an application to the second OS. For example, the user places a web shortcut into an application dock in the second OS or the user installs an application from the second OS application catalog server. The second OS application manager stores 1010 the data about the newly added application in a shared folder that is readable from the default OS.

The user shuts down 1015 the second OS. When the user enters 1020 the default OS, the default OS application manager reads 1025 the data relating to the newly added application from the shared folder. In one embodiment, the default OS application manager prompts 1030 the user to confirm whether the newly added application should be added to the default OS as well.

When the newly added application is a web shortcut, the default OS application manager creates 1035 the shortcut within the default OS. For example, the shortcut is added to the start menu, the desktop, an application launch bar, etc. When the newly added application is a local application, the default OS application manager checks the second OS application catalog server to determine whether a version for the default OS is available. If a default OS version is available, the default OS manager downloads 1040 and installs 1045 the OS application.

This flow process is also applicable to deleting applications from an environment.

### Installation

The synchronization system 108 is incorporated into the client by an original equipment manufacturer (OEM) or is sold separately as software. The synchronization system 108 functions on a client where a second OS, such as Windows® is installed after-market. In this situation, the synchronization system 108 injects applications or modifications into the second OS. In this instance, the synchronization system 108 saves the user from having to configure all the preferences in the second OS that were already specified for the pre-installed OS.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

1. A computer-implemented method for synchronizing between a plurality of environments using a shared storage location, comprising the steps of:
starting, with a computer, a first environment;
updating, with the computer, any of settings and files for the first environment;
exporting, with the computer, any of the settings and files to the shared folder in a format that is readable by a second environment;
shutting down or suspending, with the computer, the first environment;
starting, with the computer, the second environment;
reading, with the computer, any of the settings and files from the shared storage location; and
synchronizing, with the computer, any of the settings and files for the second environment with any of the settings and files for the first environment.

2. The method of claim 1, further comprising the steps of:
updating, with the computer, any of the settings and files for the second environment;
exporting, with the computer, any of the updated settings and files to the shared folder in a format that is readable by the first environment.

3. The method of claim 1, wherein the settings comprise any of network settings, browser settings, local application settings, web application settings, configuration settings, and account settings.

4. The method of claim 1, wherein the files comprise any of digital photographs, maps, directions, personal information manager data, and documents.

5. The method of claim 1, wherein the first environment comprises a default operating system and wherein the second environment comprises a second operating system.

6. The method of claim 1, wherein the environment comprises any of an operating system, a state of an operating system, and a virtual machine.

7. The method of claim 1, further comprising the steps of:
alerting, with the computer, the user that any of the settings and files are updated; and
requesting, with the computer, that the user confirm that any of the settings and files are to be updated on the second environment.

8. The method of claim 1, wherein the shared folder is stored on any of a hard drive, onboard flash, external flash, a remote server, and random-access memory.

9. A computer-implemented method for synchronizing between a plurality of environments using a master folder, comprising the steps of:
starting, with a computer, a first environment;
updating, with the computer, any of settings and files for the first environment;
storing, with the computer, any of the settings and files in a folder within the first environment;
shutting down, with the computer, the first environment;
starting, with the computer, a second environment;
reading, with the computer, any of the settings and files from the folder within the first environment; and
synchronizing, with the computer, any of the settings and files for the second environment with any of the settings and files for the first environment.

10. The method of claim 9, wherein any of the settings and files comprises digital photos and further comprising the step of:
transferring from a digital camera to the computer digital photos.

11. The method of claim 9, wherein the settings comprise:
configuration settings including, but not limited to, language, keyboard, font size, date, time, time zone, location, screen resolution, screen brightness, power options, performance options, mouse sensitivity, track pad sensitivity, idle screen saver timers, and background themes;
network settings including wireless fidelity (WiFi) network names, passwords, keys, connection priorities, whether or not the client should join open networks, 3G/wireless wide area network (WWAN) network choice, personal identification number (PIN) or password, auto-connect on/off setting, roaming on/off setting, digital subscriber line (DSL) user name and password, and internet protocol (IP) and DNS address settings;
browser settings including bookmarks, favorites, history, cookies, home page address, stored form data, stored username and password data for web sites, tags, folders, information used to classify bookmarks, favorites, other websites, certificates, skins and browser customizations, add-ons, extensions, plug-ins, trusted site security lists, blocked site lists, virus patterns, and last setting;
local and web applications; and
account settings including usernames, passwords, and biometric data.

12. The method of claim 9, wherein the files comprise:
documents including office programs, media files, and metadata;
maps and directions; and
personal information management data including contacts and calendar information.

13. A system for synchronizing data in a plurality of environments in a computer comprising:
a first environment configured to receive files, update any of files and settings, and exports any of the updated settings and files to a shared folder;
the shared folder comprising any of local and remote storage, the shared folder configured to receive updated settings and files from the first environment and providing the updated settings and files to a second environment; and
the second environment configured to read any of the updated settings and files from the shared folder and configured to synchronize any of the updated settings and files with the first environment,
wherein the second environment is accessible after the first environment is shut down or suspended.

14. The system of claim 13, wherein the settings comprise any of network settings, browser settings, local application settings, web application settings, configuration settings, and account settings.

15. The system of claim 13 wherein the files comprise any of digital photographs, maps, directions, personal information manager data, and documents.

16. The system of claim 13, wherein the first environment is a default operating system and wherein the second environment is a second operating system that is embedded in a system boot read-only memory of the computer.

17. The system of claim 13, wherein the second OS further comprises a user interface (UI) that is displayed in response to selecting a home key.

18. The system of claim 17, wherein the home key is reassigned to any key on the computer or on a peripheral device that is attached to the computer.

19. The system of claim 17, wherein the first environment comprises a default OS and the second OS UI is displayed regardless of a state of the default OS.

20. The system of claim 19, wherein the default OS enters any of the following states system on, sleep, suspend, standby, hibernated, and system off.
